(19) United States
(12) Patent Application Publication
(10) Pub. No.: US 2018/0216953 A1
(43) Pub. Date: Aug. 2, 2018

(54) AUDIO-GUIDED NAVIGATION DEVICE

(71) Applicant: SHARP KABUSHIKI KAISHA, Sakai City, Osaka (JP)

(72) Inventor: TAKEAKI SUENAGA, Sakai City, Osaka (JP)

(21) Appl. No.: 15/747,211

(22) PCT Filed: Jul. 20, 2016
(86) PCT No.: PCT/JP2016/071308

§ 371 Date: Jan. 24, 2018

(30) Foreign Application Priority Data
Jul. 27, 2015 (JP) 2015-148102

(51) Int. Cl. G01C 21/36

(52) U.S. Cl. CPC G01C 21/3629

(57) ABSTRACT

An audio-guided navigation device (1) includes a user position acquiring unit (12); an environment information acquiring unit (13); and an audio signal processing unit (143) configured to generate stereophonic sound in which a virtual sound source is configured at a leading position ahead of a user position on a route. The audio signal processing unit (143) is configured to add an acoustic effect corresponding to environment information to an audio signal.

### TECHNICAL FIELD

The present invention relates to an audio-guided navigation technique for providing navigation to a user by presenting a route with an audio signal.

### BACKGROUND ART

Personal information terminals, notably smartphones, have been widespread significantly in recent years. A combination of such a personal terminal and an application operable on the terminal enables a user to receive various types of information depending on the occasion. The information terminal includes, as a standard, various sensors, such as a Global Positioning System (GPS) sensor, a gyroscope, and an acceleration sensor, in addition to a high-performance processor configured to process applications. Thus, the information terminal generally combines various pieces of information acquired by the sensors to recognize user's actions and a surrounding environment and feeds them back to information to be provided to the user.

Navigation applications are one of typical applications operable on the terminal. A navigation application that presents, on a display of the terminal, map information or path information to which an own position acquired by the GPS is added is used by many users now (for example, PTL 1).

Unfortunately, with a navigation device that displays map information or path information on a display as disclosed in PTL 1, a user is required to watch the display closely to acquire information. It is thus difficult for the user to use the navigation device while performing “travel to a destination”, which is the main purpose of using the navigation device. Often the user is required to make an exclusive choice of an action between “travel” and “information acquisition”.

On the other hand, PTL 2 discloses a navigation device that presents information with audio. The navigation device described in PTL 2 does not require a user to watch a display closely in a case of presenting information with audio through a speaker embedded in the navigation device or an earphone or a headset connected with the navigation device, so that information acquisition does not prevent travel like the aforementioned case.

Unfortunately, concerning information transmitted in navigation, information presented with audio generally has a tendency to be less dense than information presented with an image through a display or the like.

The technique described in PTL 2 utilizes a stereophonic sound technique and adds “direction” information to audio to increase the density of information presented with the audio. It is expected that adding “direction” information to audio provides intuitive and natural information presentation to a user.

### CITATION LIST

### Patent Literature

PTL 1: JP 2006-126402 A (published on May 18, 2006)

PTL 2: JP 07-103781 A (published on Apr. 18, 1995)

### SUMMARY OF INVENTION

### Technical Problem

Unfortunately, the inventors have found that audio-guided navigation techniques according to the related art may not provide a user with navigation that can be intuitively and readily understood.

For example, as illustrated in FIG. 6A, in a case of navigating a user located in a user position 61 along a path 63 to a destination 62 that is visually recognizable to the user, navigation audio is presented to the user as if the audio is emitted at the destination 62 toward the user position 61. This presentation allows the user to intuitively know the destination 62. However, as illustrated in FIG. 6B, in a case of the destination 62 that is not visually recognizable because of a building 64 being a blocking body existing between the destination 62 and the user position 61, presentation of navigation audio in the same manner as in a case of the destination 62 that is visually recognizable is against intuition of the user, according to the finding of the inventors.

To solve the above problem, a main object of the present invention is to provide an audio-guided navigation technique for providing navigation that can be more intuitively and readily understood by a user.

### Solution to Problem

To solve the above problem, an audio-guided navigation device according to an aspect of the present invention presents a route with an audio signal, the audio-guided navigation device including: a user position acquiring unit configured to acquire a user position; an environment information acquiring unit configured to acquire environment information indicating an object existing in a vicinity of the user position; and an audio signal processing unit configured to generate stereophonic sound in which a virtual sound source configured to emit the audio signal is configured at a leading position ahead of the user position on the route. The audio signal processing unit is configured to add an acoustic effect corresponding to the environment information to the audio signal.

### Advantageous Effects of Invention

An aspect of the present invention provides an audio-guided navigation technique for providing navigation that can be more intuitively and readily understood by a user.

### BRIEF DESCRIPTION OF DRAWINGS

FIG. 1 is a block diagram illustrating a configuration of the main portion of an audio-guided navigation device according to an embodiment of the present invention.

FIG. 2 is a block diagram illustrating a configuration of the main portion of an audio-guided navigation system according to the embodiment of the present invention.

FIGS. 3A and 3B are diagrams illustrating examples of relationships between a user position and an audio signal presentation position according to the embodiment of the present invention.

FIG. 4 is a diagram illustrating an example of a relationship between the user position and the audio signal presentation position according to the embodiment of the present invention.

FIG. 5 is a diagram illustrating an example of an environment in the vicinity of a user according to the embodiment of the present invention.

FIGS. 6A and 6B are diagrams illustrating examples of operations of an audio-guided navigation device according to the related art.

FIGS. 7A and 7B are diagrams illustrating examples of environments in the vicinity of the user according to the embodiment of the present invention.

FIG. 8 is a flowchart describing an example of a flow of an audio signal processing process according to the embodiment of the present invention.

FIG. 9 is a table showing an example of environment information according to the embodiment of the present invention.

FIG. 10 is a block diagram illustrating a configuration of the main portion of an audio-guided navigation device according to a modified example of the present invention.

### DESCRIPTION OF EMBODIMENTS

### Embodiment 1

An embodiment (Embodiment 1) of the present invention will be described below with reference to the drawings.

### Audio-Guided Navigation Device 1 and Audio-Guided Navigation System 2

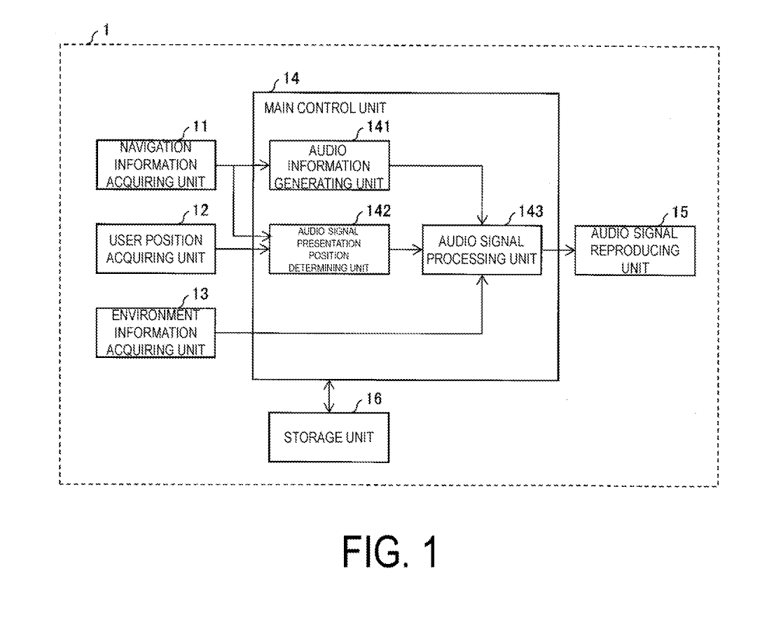

FIG. 1 is a block diagram illustrating a main configuration of an audio-guided navigation device 1 according to Embodiment 1 of the present invention. The audio-guided navigation device 1 according to the present embodiment presents a route with an audio signal, and as illustrated in FIG. 1, includes a navigation information acquiring unit 11, a user position acquiring unit 12, an environment information acquiring unit 13, a main control unit 14, an audio signal reproducing unit 15, and a storage unit 16. The main control unit 14 includes an audio information generating unit 141, an audio signal presentation position determining unit 142, and an audio signal processing unit 143.

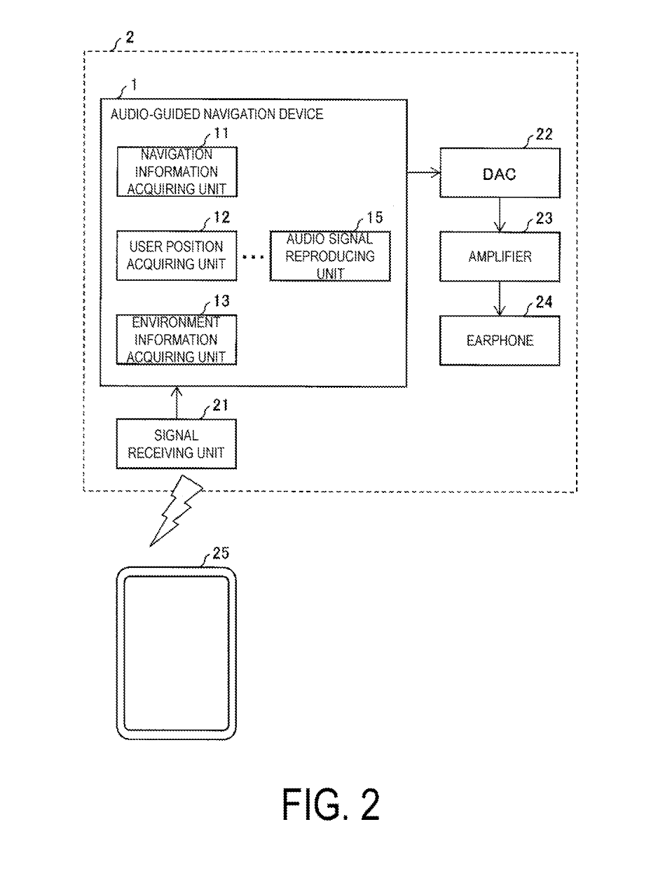

The audio-guided navigation device 1 according to the present embodiment can be incorporated in audio-guided navigation systems having various configurations, for example, an audio-guided navigation system 2 illustrated in FIG. 2, that acquires various pieces of information from a portable terminal 25 and outputs an audio signal from an earphone 24. As illustrated in FIG. 2, the audio-guided navigation system 2 includes the audio-guided navigation device 1, a signal receiving unit 21, a digital-to-analog converter (DAC) 22, an amplifier 23, and the earphone 24.

Note that in the present specification, navigation, which in other words is a route guide, indicates presentation of a route to be followed by a user, to the user.

### Navigation Information Acquiring Unit 11

The navigation information acquiring unit 11 is configured to acquire navigation information indicating a route to be presented to a user. In the present embodiment, the navigation information (guide information) indicates a way along which a user is guided from a desired point to a destination and includes information on a path and a route and information on a means of transportation for each of the path and the route. The information on a path and a route includes, for example, a main intersection and indication of a right turn or a left turn at a junction.

The navigation information acquiring unit 11 may acquire the navigation information as metadata information written in a desired format, such as Extensible Markup Language (XML). In this case, the navigation information acquiring unit 11 is configured to appropriately decode the acquired metadata information.

In the present embodiment, the navigation information acquiring unit 11 is configured to acquire the navigation information from the portable terminal 25 through the signal receiving unit 21 of the audio-guided navigation system 2. However, the present invention is not limited to this configuration, and the navigation information acquiring unit 11 may acquire the navigation information from the storage unit 16 or from an external server through a network.

### User Position Acquiring Unit 12

The user position acquiring unit 12 is configured to acquire a user position being a current position of the user. In the present embodiment, the user position acquiring unit 12 is configured to acquire the user position from the portable terminal 25 through the signal receiving unit 21 of the audio-guided navigation system 2. However, the present invention is not limited to this configuration, and the user position acquiring unit 12 may acquire the user position based on output from various sensors or the like connected to the audio-guided navigation device 1, output from the Global Positioning System (GPS), or the like. Alternatively, the user position acquiring unit 12 may acquire a current location acquired through communication with a base station of a wireless Local Area Network (LAN) of which the installation location is known, Bluetooth (trade name), or the like, as the user position.

### Environment Information Acquiring Unit 13

The environment information acquiring unit 13 is configured to acquire environment information in the vicinity of the user position. In the present specification, the environment information includes at least information indicating an object existing in the vicinity of the user position. In the present specification, the object includes structures (such as buildings, roads, and tunnels), installed bodies (such as signs), geographic features (such as hills and mountains), various landmarks, and trees.

In the present embodiment, the environment information acquiring unit 13 is configured to acquire map information in the vicinity of the user position. The map information includes information on a surrounding geographic feature, the size of a surrounding structure or landmark, and information on a main road.

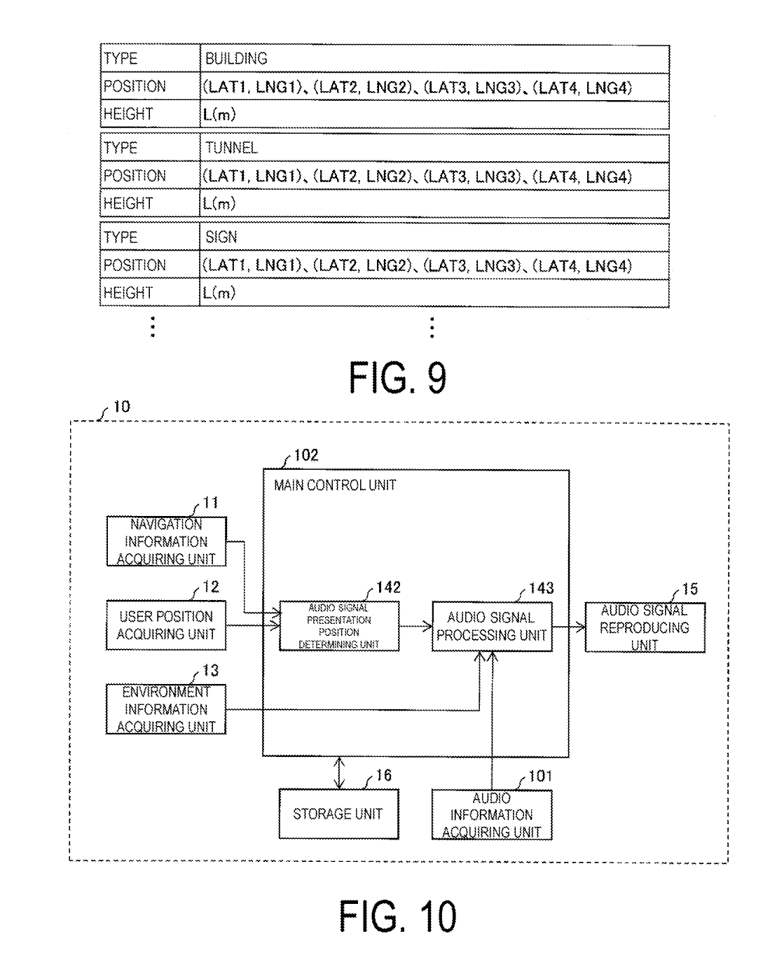

FIG. 9 is a table showing an example of environment information according to the present embodiment. As shown in FIG. 9, information on objects existing in the vicinity of the user position is listed in the environment information. The information on an object includes the type of object, positional information on the object, and height information on the object. In the example shown in FIG. 9, the positional information on an object is indicated by latitude/longitude information on each of the apices of a shape of a ground contacting part of the object (a floor in a case of a structure).

In the present embodiment, the environment information acquiring unit 13 is configured to acquire the environment information from the portable terminal 25 through the signal receiving unit 21 of the audio-guided navigation system 2. However, the present invention is not limited to this configuration, and the environment information acquiring unit 13 may acquire the environment information from various sensors or the like connected to the audio-guided navigation device 1, from the storage unit 16, or from an external server through a network.

### Main Control Unit 14

The main control unit 14 is configured to control the navigation information acquiring unit 11, the user position acquiring unit 12, the environment information acquiring unit 13, and the storage unit 16 in a centralized manner, and exchange data with each of these units. The main control unit 14 is achieved by, for example, executing a program stored in a prescribed memory by a Central Processing Unit (CPU).

### Audio Signal Reproducing Unit 15

The audio signal reproducing unit 15 is configured to output an audio signal (stereophonic sound) subjected to audio signal processing (acoustic effect processing) by the main control unit 14. In the present embodiment, the audio signal output from the audio signal reproducing unit 15 is presented to the user through the earphone 24. However, the present invention is not limited to this configuration, and the audio signal reproducing unit 15 may be configured to output the audio signal to various audio devices.

### Recording Unit 16

The storage unit 16 is composed of a secondary storage device configured to store various pieces of data used by the main control unit 14. The storage unit 16 is composed of, for example, a magnetic disk, an optical disk, a flash memory, or the like, and more specific examples include a Hard Disk Drive (HDD), a Solid State Drive (SSD), and a Blu-Ray (trade name) Disc (BD). The main control unit 14 can read out data from the storage unit 16 or record data in the storage unit 16 where necessary.

### Audio Information Generating Unit 141

The audio information generating unit 141 is configured to generate audio information indicating an audio signal presenting a route to the user by referring to the navigation information acquired at the navigation information acquiring unit 11. In other words, the audio information generating unit 141 is configured to convert the navigation information into the audio information indicating an audio signal to be presented to the user. For example, the audio information generating unit 141 may construct a sentence (character string data) to be presented to the user from the navigation information acquired at the navigation information acquiring unit 11 where necessary and convert the sentence into the audio information. Note that the audio information generating unit 141 may also refer to the user position acquired at the user position acquiring unit 12 to generate an audio signal.

### Audio Signal Presentation Position Determining Unit 142

The audio signal presentation position determining unit 142 is configured to determine a leading position that is ahead of the user position on the route indicated by the navigation information as an audio signal presentation position (virtual sound source position) indicated by the audio information generated at the audio information generating unit 141, based on the navigation information acquired at the navigation information acquiring unit 11 and the user position acquired at the user position acquiring unit 12.

### Audio Signal Processing Unit 143

The audio signal processing unit 143 is configured to perform audio signal processing on the audio signal indicated by the audio information generated at the audio information generating unit 141, based on the audio signal presentation position (virtual sound source position) acquired at the audio signal presentation position determining unit 142 and the environment information acquired at the environment information acquiring unit 13.

The audio signal processing will be described in detail later. The audio signal processing unit 143 is configured to generate stereophonic sound in which a virtual sound source configured to emit the audio signal is configured at the audio signal presentation position, and add an acoustic effect corresponding to the environment information to the stereophonic sound.

### Signal Receiving Unit 21

The signal receiving unit 21 is configured to receive various pieces of information through wire communication or radio communication. A radio transmission technique, such as Bluetooth (trade name) and Wi-Fi (trade name), can be used for the radio communication, but no such limitation is intended. Note that in the present embodiment, for the sake of convenience of the description, the signal receiving unit 21 acquires information through radio communication using Wi-Fi (trade name) unless otherwise indicated.

As illustrated in FIG. 2, the signal receiving unit 21 is configured to acquire various pieces of information from the portable terminal 25 being an information terminal, such as a smartphone, having a data communication function, a GPS function, and the like, and provides the information to each of the units (the navigation information acquiring unit 11, user position acquiring unit 12, and environment information acquiring unit 13) of the audio-guided navigation device 1.

### DAC 22, Amplifier 23, and Earphone 24

The DAC 22 is configured to convert a digital audio signal input from the audio-guided navigation device 1 (the audio signal reproducing unit 15) to the DAC 22 into an analog audio signal and to output the audio signal to the amplifier 23.

The amplifier 23 is configured to amplify the audio signal input from the DAC 22 to the amplifier 23 and to output the audio signal to the earphone 24.

The earphone 24 is configured to output audio based on the audio signal input from the amplifier 23 to the earphone 24.

### Audio-Guided Navigation Method

An audio-guided navigation method with the audio-guided navigation device 1 according to the present embodiment will be described below. The audio-guided navigation method according to the present embodiment includes (1) a navigation information acquiring process of acquiring the navigation information, (2) a user position acquiring process of acquiring the user position, (3) an environment information acquiring process of acquiring the environment information, (4) an audio information generating process of generating the audio information, (5) an audio signal presentation position determining process of determining the audio signal presentation position, (6) an audio signal processing process of generating the stereophonic sound, and (7) an audio signal outputting process of outputting the stereophonic sound. Note that Processes (1) to (3) may be performed in a desired order, Process (4) may be performed after Process (1) or Processes (1) and (2), Process (5) may be performed after Processes (1) and (2), Process (6) may be performed after Processes (1) to (5), and Process (7) may be performed after Process (6).

### 1. Navigation Information Acquiring Process

In the navigation information acquiring process, the navigation information acquiring unit 11 acquires the navigation information. In the present embodiment, the navigation information acquiring unit 11 acquires the navigation information from the portable terminal 25 through the signal receiving unit 21, for example.

### 2. User Position Acquiring Process

In the user position acquiring process, the user position acquiring unit 12 acquires the user position. In the present embodiment, the user position acquiring unit 12 acquires the user position from the portable terminal 25 through the signal receiving unit 21, for example.

### 3. Environment Information Acquiring Process

In the environment information acquiring process, the environment information acquiring unit 13 acquires the environment information in the vicinity of the user position. In the present embodiment, the environment information acquiring unit 13 acquires, for example, map information in the vicinity of the user position as shown in FIG. 9 as the environment information from the portable terminal 25 through the signal receiving unit 21, for example.

### 4. Audio Information Generating Process

In the audio information generating process, the audio information generating unit 141 generates the audio information indicating an audio signal presenting a route to the user by referring to the navigation information acquired at the navigation information acquiring unit 11. In the present embodiment, the audio information generating unit 141 converts, for example, a main intersection and indication of a right turn or a left turn at a junction included in the navigation information into a corresponding sentence (character string data) and then converts the sentence into audio information with a known artificial audio synthesizing technique.

### 5. Audio Signal Presentation Position Determining Process

In the audio signal presentation position determining process, the audio signal presentation position determining unit 142 determines a position (direction, distance) of presenting the audio signal for audio-guided navigation, in order to allow the user to readily recognize a direction to be taken next. That is, the audio signal presentation position determining unit 142 considers the route (path), indicated by the navigation information, to be followed by the user and the user position, and determines a leading position ahead of the user position on the selected route as the audio signal presentation position, based on information on a junction or the like on the way of the user and a distance to the junction or the like.

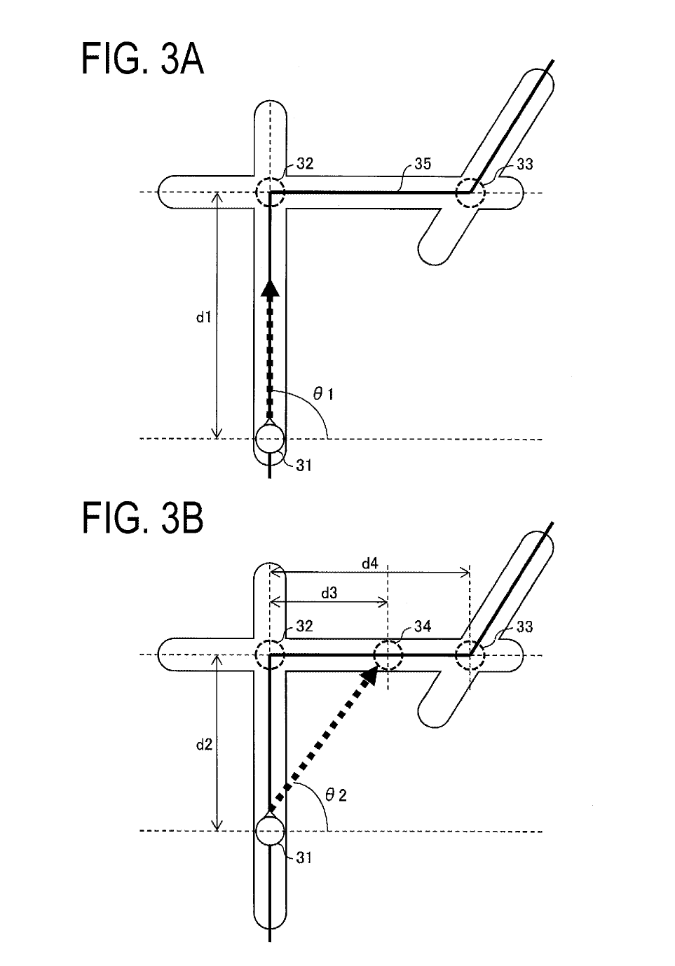

FIGS. 3A and 3B are diagrams illustrating examples of relationships between a user position 31 and an audio signal presentation position according to the present embodiment. In the examples illustrated in FIGS. 3A and 3B, the user is traveling along a route 35. The route 35 includes a junction 32 and a 5 junction 33, and indication of a right turn or a left turn at each of the junctions is provided.

As illustrated in FIG. 3A, d1 indicates a distance between the user position 31 and the junction 32 being the subsequent junction. In such a case 10 that Relationship (1) below is found between d1 and a preliminarily configured threshold a, the audio signal presentation position determining unit 142 determines the junction 32 in the subsequent junction position (leading position) as the audio signal presentation position.

d1>α (1)

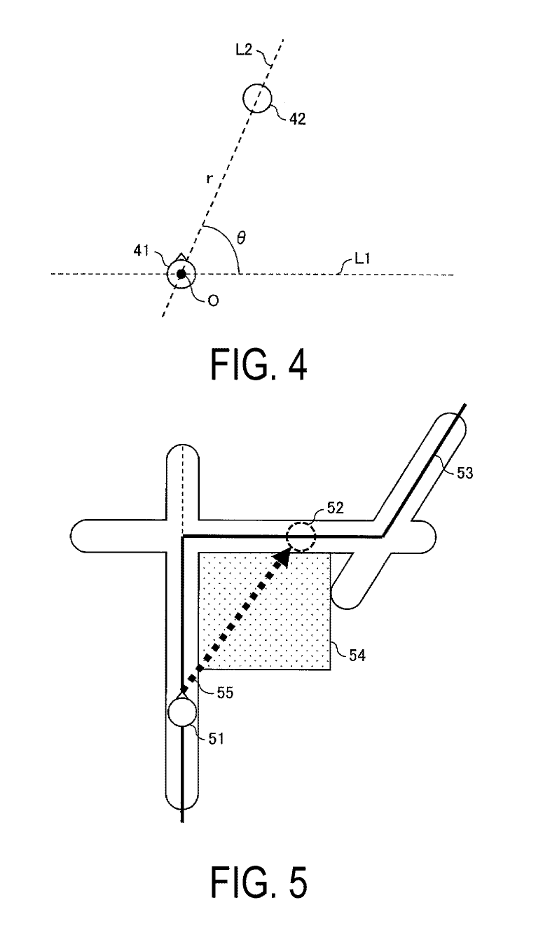

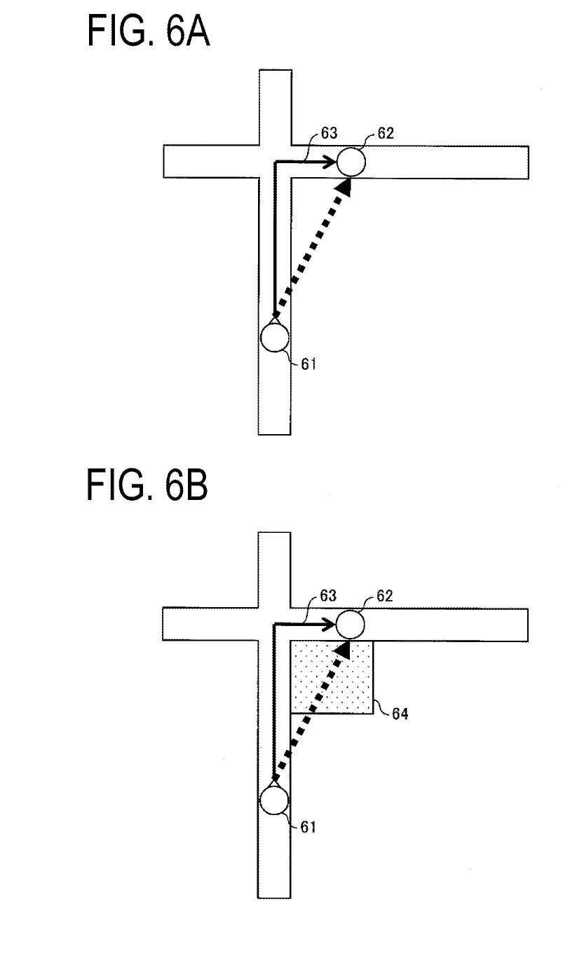

In the present embodiment, the audio signal presentation position is expressed with a prescribed coordinate system of which the origin is an intermediate point between the right ear and the left ear of the user. FIG. 4 illustrates an example of a user position 41 and an audio signal presentation position 42. Unless otherwise indicated, this coordinate system is a two-dimensional polar coordinate system composed of a distance (radius) r from the origin to the audio signal presentation position and an angle (azimuth) θ of the audio signal presentation position with reference to the origin. That is, the audio signal presentation position 42 is expressed as (r, θ) that is a combination of the distance r and the angle θ. As illustrated in FIG. 4, the angle θ of the audio signal presentation position is formed by a straight line L1 passing through the origin and extending in a specific direction and a straight line L2 connecting the origin with the audio signal presentation position 42.

Thus, in the example illustrated in FIG. 3A, the audio signal presentation position determining unit 142 determines that the audio signal presentation position is (d1, θ1), based on the relative positional relationship between the junction 32 and the user position 31.

Note that the audio signal presentation position is not limited to a subsequent junction position. For example, in such a case that the distance between the user position and the subsequent junction is equal to or greater than a predetermined threshold Th_{d}, the audio signal presentation position determining unit 142 may determine that the radius is equal to Th_{d}. That is, in such a case that the audio signal presentation position calculated from the user position and the junction position is (r, θ), the audio signal presentation position determining unit 142 may change the audio signal presentation position as expressed with Relationship (2) or (3) below.

(r,θ)(in a case of r<Th_{d}) (2)

(Th_{d},θ)(in a case of r≥Th_{d}) (3)

As illustrated in FIG. 3B, in such a case that Relationship (4) below is found between a distance d2 between the user position 31 and the junction 32 being the subsequent junction and the threshold a, the audio signal presentation position determining unit 142 may determine a position (leading position) further ahead of the junction 32 in the subsequent junction position as the audio signal presentation position.

d2≤α (4)

In the example illustrated in FIG. 3B, the audio signal presentation position determining unit 142 determines a point (leading position) 34 away from the junction 32 by a distance d3 on the route (path) as the audio signal presentation position. That is, in the example illustrated in FIG. 3B, the audio signal presentation position determining unit 142 determines that the audio signal presentation position is (r2, θ2), based on the relative positional relationship between the point 34 and the user position 31. Note that r2=√(d2×d2+d3×d3). The audio signal presentation position determining unit 142 normally uses a parameter D preliminarily configured in the device as d3, but in such a case that D exceeds a distance d4 between the junction 32 and the subsequent junction 33, determines that d3=d4. That is, d3 can be expressed with Equation (5) or (6) below.

d3=D(in a case of D≥d4) (5)

d3=d4(in a case of D<d4) (6)

After the user reaches the junction 33, the above operation is repeated.

### 6. Audio Signal Processing Process

In the audio signal processing process, the audio signal processing unit 143 first adds an acoustic effect corresponding to the environment indicated by the environment information acquired at the environment information acquiring unit 13, to the audio signal input from the audio information generating unit 141. Next, the audio signal processing unit 143 configures a virtual sound source of the audio signal to which the acoustic effect is added, at the audio signal presentation position notified by the audio signal presentation position determining unit 142 to generate stereophonic sound. The audio signal processing process will be described in detail below with reference to the drawings.

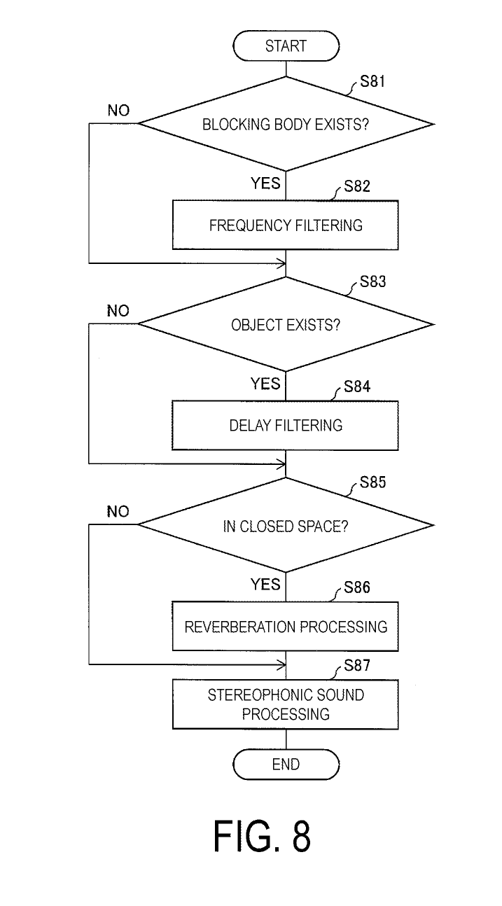

FIG. 8 is a flowchart describing an example of a flow of the audio signal processing process according to the present embodiment.

In Step S81, the audio signal processing unit 143 refers to the environment information acquired at the environment information acquiring unit 13 to determine whether a blocking body exists between the audio signal presentation position acquired at the audio signal presentation position determining unit 142 and the user position acquired at the user position acquiring unit 12.

For the sake of the description, a case in which a building (blocking body, structure, object) 54 exists between a user position 51 and an audio signal presentation position 52 ahead of the user position 51 on a route 53 as illustrated in FIG. 5 is taken as an example. In this case, the environment information includes information on an object of which the type is a building as listed in the first row of FIG. 9, for example.

The audio signal processing unit 143 can determine whether the building 54 is a blocking body by performing intersection determination on each of the sides composing the building 54 and a line segment 55 connecting the user position 51 with the audio signal presentation position 52. More specifically, the audio signal processing unit 143 calculates a vector product of each of the sides composing the building 54 and the line segment 55, and in such a case that even one of these combinations has a product equal to or less than 0, can determine that the building 54 is a blocking body. In other cases, the audio signal processing unit 143 determines that the building 54 is not a blocking body.

The audio signal processing unit 143 performs the above step on each of objects included in the environment information and can thus determine whether a blocking body exists between the user position 51 and the audio signal presentation position 52.

Note that in the present embodiment, for the sake of convenience of the description, determination of whether a blocking body exists is made on a two-dimensional plane. However, in such a case that the environment information includes height information or the like as shown in FIG. 9, the audio signal processing unit 143 may determine whether a blocking body exists in consideration of the height information or the like. For example, a body height h preliminarily input by the user is compared with height information L in the environment information. In such a case that a relationship of h≤L is satisfied, it is determined that a blocking body exists in the height direction. In such a case that a relationship of h>L is satisfied, it is determined that no blocking body exists in the height direction. In the case of no blocking body existing in the height direction, the audio signal processing unit 143 determines that no blocking body exists regardless of a result of the above-described intersection determination on the building 54 and the line segment 55. This operation enables determination further corresponding to the situation of the real space. Furthermore, in such a case that the environment information includes three-dimensional shape data of the building 54, the audio signal processing unit 143 may perform the intersection determination based on the data and determine whether the building 54 is in a blocking state.

In the case in which the audio signal processing unit 143 determines that a blocking body exists between the user position and the audio signal presentation position (YES in Step S81), the procedure proceeds to Step S82. In the case in which the audio signal processing unit 143 determines that no blocking body exists between the user position and the audio signal presentation position (NO in Step S81), the procedure skips Step S82 and proceeds to Step S83.

In Step S82, the audio signal processing unit 143 adds an acoustic effect corresponding to the building 54 being a blocking body, to the audio signal. The acoustic effect can be added through one or more types of digital filtering. To generate stereophonic sound simulating sound of the real space changed by the blocking body existing between the user position and the audio signal presentation position, the audio signal processing unit 143 performs frequency filtering for attenuation (including cut-off) of at least one of a high frequency domain and a low frequency domain in a frequency domain of the audio signal. The frequency to be attenuated (cut off) at this time can be preliminarily configured in the device, and be read out by the audio signal processing unit 143 from the storage unit 16 as appropriate.

Note that the audio signal processing unit 143 may change the frequency to be attenuated (cut off) depending on the “type” (the type of blocking body) being one item in the environment information. For example, in such a case that a blocking body of which the type is indicated as “building” exists, the audio 10 signal processing unit 143 may be configured to cut off or attenuate a wider frequency domain than in such a case that a blocking body of which the type is indicated as “sign” exists. This is because a building mainly made from iron rods or concrete has a tendency to cut off sound better than a sign, in the real space. The audio signal processing unit 143 may change the amount of attenuation instead of or in addition to the frequency domain to be attenuated, depending on the type of blocking body. In this way, the audio signal processing unit 143 may change a coefficient in the frequency filtering depending on the type of blocking body.

In Step S83, the audio signal processing unit 143 refers to the environment information in the vicinity of the user position to determine whether an object that reflects audio emitted at the audio signal presentation position exists in the vicinity of the user position. Such objects include structures such as buildings.

In such a case that the audio signal processing unit 143 determines that an object that reflects audio emitted at the audio signal presentation position exists in the vicinity of the user position (YES in Step S83), the procedure proceeds to Step S84. In such a case that the audio signal processing unit 143 determines that no object that reflects audio emitted at the audio signal presentation position exists in the vicinity of the user position (NO in Step S83), the procedure skips Step S84 and proceeds to Step S85.

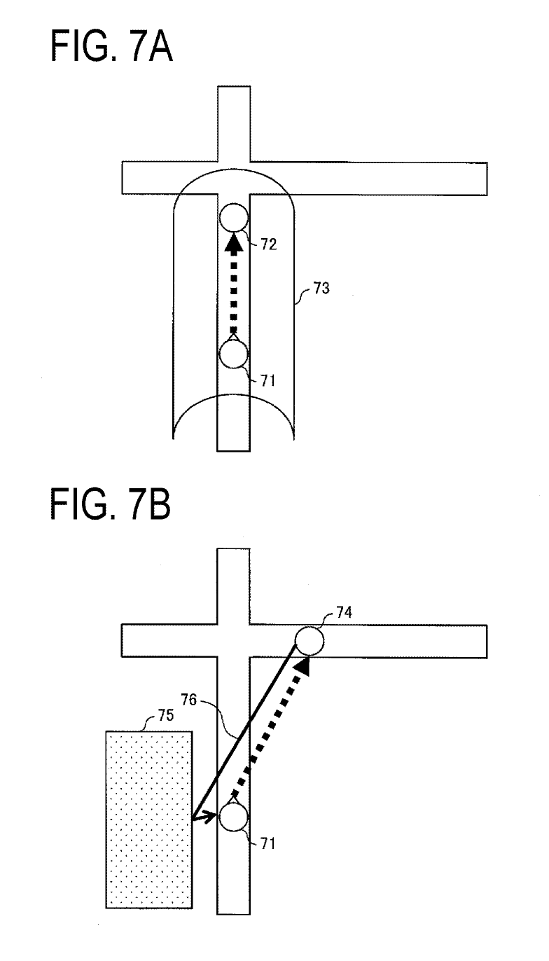

In Step S84, to reproduce a reflected wave with which audio 76 emitted at an audio signal presentation position 74 is reflected off a building (structure, object) 75 and reaches a user position 71 as illustrated in FIG. 7B, the audio signal processing unit 143 performs delay filtering on the audio signal. The audio signal processing unit 143 generates the reflected wave in this way, so that an effect of the object included in the environment in the vicinity of the user position on transmission of sound in the real space can be simulated.

In Step S85, the audio signal processing unit 143 refers to the environment information in the vicinity of the user position to determine whether both of the user position and the audio signal presentation position are in a closed space. Objects defining a closed space include tunnels. The audio signal processing unit 143 may determine whether both the user position and the audio signal presentation position are in a closed space, with a known algorithm for determining the inside and the outside.

In such a case that the audio signal processing unit 143 determines that both the user position and the audio signal presentation position are in a closed space (YES in Step S85), the procedure proceeds to Step S86. In such a case that the audio signal processing unit 143 determines that at least one of the user position and the audio signal presentation position is not in a closed space (NO in Step S85), the procedure skips Step S86 and proceeds to Step S87.

In Step S86, in such a case that both the user position 71 and the audio signal presentation position 72 are in a specific closed space, such as a tunnel (object) 73 as illustrated in FIG. 7A, the audio signal processing unit 143 generates a reverberation corresponding to the closed space for the audio signal in order to reproduce sound in the closed space.

Note that the configuration in which, in such a case that a blocking body, an object reflecting sound, or a closed space is included in the environment in the vicinity of the user position, the corresponding acoustic effect is added to the audio signal has been described for Steps S81 to S86 of the present embodiment. However, this configuration is merely an example and should not be construed to limit the present invention. That is, the audio signal processing unit 143 may be configured to add an acoustic effect corresponding to only one of a blocking body, an object reflecting sound, and a closed space, or to add an acoustic effect corresponding to an object other than a blocking body, an object reflecting sound, and a closed space, to the audio signal. Furthermore, the order of adding the acoustic effects is not limited to the flow in FIG. 8. For example, the delay filtering performed in S84 may be performed before the frequency filtering performed in S82. In any case, the audio signal processing unit 143 can provide navigation that can be more intuitively and readily understood by the user by adding such an acoustic effect to the audio signal as to simulate an effect of an object included in the environment in the vicinity of the user position on transmission of sound in the real space.

Next, in Step S87, the audio signal processing unit 143 applies a Head Related Transfer Function (HRTF) to the audio signal to which the acoustic effect corresponding to the environment information is added, to make a conversion into a stereophonic audio signal with the position of the virtual sound source of the audio signal coinciding with the audio signal presentation 10 position. Specifically, as expressed in Equations (7) and (8) below, the audio signal processing unit 143 multiplies each of N (N represents a natural number) pieces of input signals Iₙ(z) by HLₙ(z) and HRₙ(z) being HRTFs and adds up Iₙ(z)HLₙ(z) and Iₙ(z)HRₙ(z) after the multiplication to generate a left ear signal L_{OUT} and a right ear signal R_{OUT}.

[Equation 1]

L_{OUT}=dΣIₙ(z)HLₙ(z) (7)

R_{OUT}=dΣIₙ(z)HRₙ(z) (8)

Note that in Equations (7) and (8) above, n=1, 2, . . . , N. HLₙ(z) represents the HRTF for the left ear in the audio signal presentation position (azimuth) configured for the input signal Iₙ(z). HRₙ(z) represents the HRTF for the right ear in the audio signal presentation position (azimuth) configured for the input signal Iₙ(z). In the present embodiment, these HRTFs are preliminarily stored in the storage unit 16, as discrete table information. The coefficient d indicates the amount of attenuation based on the distance r from the origin (user position) to the virtual sound source (audio signal presentation position), and is expressed by Equation (9) below in the present embodiment.

d=1/(r+ε) (9)

where r is a distance from the origin to the audio signal presentation position, and ε is a preliminarily configured coefficient.

Lastly, the audio signal processing unit 143 outputs the generated stereophonic audio signal (left ear signal L_{OUT} and right ear signal R_{OUT}) to the audio signal reproducing unit 15.

### 7. Audio Signal Outputting Process

The audio signal reproducing unit 15 converts the stereophonic left ear signal L_{OUT} and right ear signal R_{OUT} generated at the audio signal processing unit 143 into a digital audio signal in a desired format. The audio signal reproducing unit 15 then outputs the converted digital audio signal to a desired audio device to reproduce the stereophonic sound.

In the present embodiment, the audio signal reproducing unit 15 converts the stereophonic audio signal into, for example, a digital audio signal in Inter-IC Sound (I2S) format and outputs the digital audio signal to the DAC 22. The DAC 22 converts the digital audio signal into an analog audio signal and outputs the analog audio signal to the amplifier 23. The amplifier 23 amplifies the analog audio signal and outputs the amplified analog audio signal to the earphone 24. The earphone 24 outputs the amplified analog audio signal toward the eardrum of the user, as audio.

The above-described operation of the present embodiment can consider the surrounding environment and provide navigation that can be more intuitively and readily understood by the user, with audio corresponding to the environment.

### Embodiment 2

Embodiment 2 of the present invention will be described below with reference to FIG. 10. The same components as those in Embodiment 1 described above have the same reference signs, and detailed descriptions thereof will be omitted.

Embodiment 1 has the configuration in which the main control unit 14 generates the audio information based on the navigation information acquired at the navigation information acquiring unit 11; however, the present invention is not limited to this configuration. In the present embodiment, an audio-guided navigation device 10 is configured to acquire prepared audio information. This configuration eliminates the need for generating audio information at a main control unit 102 of the audio-guided navigation device 10 and can thus reduce a load on the main control unit 102.

The audio-guided navigation device 10 according to the present embodiment includes an audio information acquiring unit 101, the navigation information acquiring unit 11, the user position acquiring unit 12, the environment information acquiring unit 13, the main control unit 102, the audio signal reproducing unit 15, and the storage unit 16. The control unit 102 includes the audio signal presentation position determining unit 142 and the audio signal processing unit 143.

The audio information acquiring unit 101 acquires audio information for providing navigation to a user from an information terminal, such as a smartphone, and provides the audio information to the main control unit 102. The main control unit 102 performs such control that the audio signal processing unit 143 adds an acoustic effect to the audio information acquired at the audio information acquiring unit 101 based on an audio signal presentation position acquired at the audio signal presentation position determining unit 142 and environment information acquired at the environment information acquiring unit 13.

In other words, an audio information acquiring process in which the audio information acquiring unit 101 acquires an audio signal for presenting a route to the user may be performed instead of “4. Audio Information Generating Process” in the audio-guided navigation method of Embodiment 1.

Similar to Embodiment 1, the above-described operation can consider the surrounding environment and provide navigation that can be more intuitively and readily understood by the user, with audio corresponding to the environment.

Example for Achievement with Software

The control blocks (especially the main control unit 14, 102) of the audio-guided navigation device 1, 10 may be achieved with a logic circuit (hardware) formed as an integrated circuit (IC chip) or the like, or with software using a Central Processing Unit (CPU).

In the latter case, the audio-guided navigation device 1, 10 includes a CPU configured to perform commands of a program being software for achieving the functions, a Read Only Memory (ROM) or a storage device (these are referred to as “recording medium”) in which the program and various pieces of data are recorded in a computer- (or CPU-) readable manner, and a Random Access Memory (RAM) in which the program is loaded. The computer (or CPU) reads the program from the recording medium and performs the program, so that the object of the present invention is achieved. The recording medium may be a “permanent and tangible medium”, for example, a tape, disk, card, semiconductor memory, and programmable logic circuit. The program may be supplied to the computer through a desired transmission medium (such as a communication network and a broadcast wave) that can transmit the program. Note that in the present invention, the program may be achieved in a form of a data signal realized through electronic transmission and embedded in a carrier wave.

### SUMMARY

An audio-guided navigation device 1, 10 according to Aspect 1 of the present invention presents a route with an audio signal. The audio-guided navigation device includes a user position acquiring unit 12 configured to acquire a user position, an environment information acquiring unit 13 configured to acquire environment information indicating an object existing in a vicinity of the user position, and an audio signal processing unit 143 configured to generate stereophonic sound in which a virtual sound source configured to emit the audio signal is configured at a leading position ahead of the user position on the route. The audio signal processing unit is configured to add an acoustic effect corresponding to the environment information to the stereophonic sound.

The above-described configuration enables the audio signal to be presented to the user as if the audio signal is emitted at the leading position toward which a user travels next, so that navigation that can be more intuitively and readily understood by the user can be provided.

Especially, the above-described configuration enables navigation of the user only with audio, so that the user's view is not obstructed. Thus, the user can visually recognize the surrounding situation. At this time, the above-described configuration can generate stereophonic sound to which an acoustic effect provided by the surrounding situation indicated in the environment information is added, so that the user can receive the presented audio more naturally.

In an audio-guided navigation device according to Aspect 2 of the present invention, the audio signal processing unit of Aspect 1 described above may be configured to refer to the environment information, determine whether a blocking body exists between the user position and the leading position, and in such a case that a blocking body exists, attenuate at least one of a high frequency domain and a low frequency domain of the audio signal.

The above-described configuration can reflect a change in the audio signal due to the blocking body existing between the user position and the leading position, in the stereophonic sound. Thus, navigation that can be more intuitively and readily understood by the user can be provided.

In an audio-guided navigation device according to Aspect 3 of the present invention, the audio signal processing unit of Aspect 2 described above may be configured to change at least one of a frequency domain to be attenuated and an amount of attenuation depending on a type of the blocking body.

The above-described configuration can reflect a change in the audio signal due to the blocking body existing between the user position and the leading position in consideration of even the type of blocking body (for example, in consideration of a difference between a case of the blocking body being a building and a case of the blocking body being a sign), in the stereophonic sound. Thus, navigation that can be more intuitively and readily understood by the user can be provided.

In an audio-guided navigation device according to Aspect 4 of the present invention, the audio signal processing unit of Aspects 1 to 3 described above may be configured to refer to the environment information, determine whether a structure exists in a vicinity of the user position, and in such a case that a structure exists, generate a reflected wave of the audio signal reflected off the structure.

The above-described configuration can reflect reflection of the audio signal off the structure in the vicinity of the user position, in the stereophonic sound. Thus, navigation that can be more intuitively and readily understood by the user can be provided.

In an audio-guided navigation device according to Aspect 5 of the present invention, the audio signal processing unit of Aspects 1 to 4 described above may be configured to refer to the environment information, determine whether both the user position and the leading position are in a closed space, and in such a case that both the user position and the leading position are in a closed space, generate a reverberation of the audio signal.

The above-described configuration can reflect a reverberation of the audio signal in a closed space defined by an object in the vicinity of the user position, in the stereophonic sound. Thus, navigation that can be more intuitively and readily understood by the user can be provided.

An audio-guided navigation device 1 according to Aspect 6 of the present invention may further include a navigation information acquiring unit 11 configured to acquire navigation information indicating the route, an audio information generating unit 141 configured to refer to the navigation information and generate the audio signal presenting the route, an audio signal presentation position determining unit 142 configured to refer to the navigation information and the user position and determine the leading position, and an audio signal reproducing unit 15 configured to output the stereophonic sound, in addition to the configurations of Aspects 1 to 5 described above.

With the above-described configuration, the audio-guided navigation device can refer to the navigation information and the user position to favorably generate the audio signal, and can present the audio signal to the user after performing audio signal processing.

An audio-guided navigation device 10 according to Aspect 7 of the present invention may further include a navigation information acquiring unit 11 configured to acquire navigation information indicating the route, an audio information acquiring unit 101 configured to acquire the audio signal presenting the route, an audio signal presentation position determining unit 142 configured to refer to the navigation information and the user position and determine the leading position, and an audio signal reproducing unit 15 configured to output the stereophonic sound, in addition to the configurations of Aspects 1 to 5 described above.

With the above-described configuration, the audio-guided navigation device can favorably acquire the audio signal, and can present the audio signal to the user after performing audio signal processing.

An audio-guided navigation method according to Aspect 8 of the present invention is configured to present a route with an audio signal. An audio-guided navigation method includes a user position acquiring process of acquiring a user position, an environment information acquiring process of acquiring environment information indicating an object existing in a vicinity of the user position, and an audio signal processing process of generating stereophonic sound in which a virtual sound source configured to emit the audio signal is configured at a leading position ahead of the user position on the route. The audio signal processing process adds an acoustic effect corresponding to the environment information to the stereophonic sound.

The above-described configuration has an effect equivalent to that of the audio-guided navigation device according to the present invention.

The audio-guided navigation device according to each of Aspects of the present invention may be achieved with a computer. In this case, an audio-guided navigation program of the audio-guided navigation device, that achieves the audio-guided navigation device with a computer operating as each of components (software elements) of the audio-guided navigation device, and a computer-readable recording medium in which the audio-guided navigation program is recorded are also within the scope of the present invention.

The present invention is not limited to each of the above-described embodiments. It is possible to make various modifications within the scope of the claims. An embodiment obtained by appropriately combining technical elements each disclosed in different embodiments falls also within the technical scope of the present invention. Further, when technical elements disclosed in the respective embodiments are combined, it is possible to form a new technical feature.

### CROSS-REFERENCE TO RELATED APPLICATION

This international application claims priority to JP 2015-148102, filed on Jul. 27, 2015, and the total contents thereof are hereby incorporated by reference.

### REFERENCE SIGNS LIST

1, 10 Audio-guided navigation device
11 Navigation information acquiring unit
12 User position acquiring unit
13 Environment information acquiring unit
14, 102 Main control unit
141 Audio information generating unit
142 Audio signal presentation position determining unit
143 Audio signal processing unit
15 Audio signal reproducing unit
16 Storage unit
101 Audio information acquiring unit
2 Audio-guided navigation system
21 Signal receiving unit
22 DAC
23 Amplifier
24 Earphone
31, 41, 51, 61, 71 User position
32, 34, 42, 52, 62, 72, 74 Leading position
54, 64 Building (Object, Structure, Blocking body)
73 Tunnel (Object)
75 Building (Structure, Object)

1. An audio-guided navigation device configured to present a route with an audio signal, the audio-guided navigation device comprising:
a user position acquiring circuitry configured to acquire a user position;
an environment information acquiring circuitry configured to acquire environment information indicating a type, a position, and a height of an object existing in a vicinity of the user position; and
an audio signal processing circuitry configured to generate sound in which a virtual sound source configured to emit the audio signal is configured at a leading position ahead of the user position on the route;
wherein the audio signal processing circuitry is configured to add an acoustic effect corresponding to the environment information to the audio signal.

2. The audio-guided navigation device according to claim 1,
wherein the audio signal processing circuitry is configured to refer to the environment information, determine whether a blocking body exists between the user position and the leading position, and in such a case that a blocking body exists, attenuate at least one of a high frequency domain and a low frequency domain of the audio signal depending on a type of the blocking body.

3. The audio-guided navigation device according to claim 2,
wherein the audio signal processing circuitry is configured to change at least one of a frequency domain to be attenuated and an amount of attenuation depending on a type of the blocking body.

4. The audio-guided navigation device according to claim 1,
wherein the audio signal processing circuitry is configured to refer to the environment information, determine whether a structure exists in a vicinity of the user position, and in such a case that a structure exists, generate a reflected wave of the audio signal reflected off the structure.

5. The audio-guided navigation device according to claim 1,
wherein the audio signal processing circuitry is configured to refer to the environment information, determine whether both the user position and the leading position are in a closed space, and in such a case that both the user position and the leading position are in a closed space, generate a reverberation of the audio signal.

6. (canceled)

7. The audio-guided navigation device according to claim 1,
wherein the audio signal processing circuitry is configured to determine whether a blocking body exists between the user position and the leading position, on the basis of the position and the height of the object, and in such a case that a blocking body exists, add an acoustic effect corresponding to the environment information to the audio signal.

8. A computer-readable non-transitory recording medium in which a program causing a computer to function as the audio-guided navigation device according to claim 1 is recorded.
